(19) United States
(12) Patent Application Publication
(10) Pub. No.: US 2013/0007099 A1
(43) Pub. Date: Jan. 3, 2013

(54) System and Method for Interactive Identification and Matching of Funding and/or Advisory Seekers and Funding and/or Advisory Providers

(76) Inventor: Michael Lee, Westmount (CA)

(21) Appl. No.: 13/174,389

(22) Filed: Jun. 30, 2011

(51) Int. Cl. G06F 15/16

(52) U.S. Cl. 709/203

(57) ABSTRACT

Systems and methods are provided to match and facilitate relationships among various clients. In one embodiment, the system connects to a web-connected database to find plurality of different funding and/or advisory programs, product, or service that match parameters for corresponding clients. The identification and matching system incorporates a method enabling funding/advisory seekers or entrepreneurs to match their activities, projects, or corporate direction to funding/advisory providers, and relevant programs and products. Database records and search parameters are provided to facilitate the identification of beneficial opportunities for entrepreneurs with regard to tax credits, grants, loans, loan guarantees, equity funding, contests, donations, and advisory services. In another embodiment, at least one software module may be used to prompt at least one user to enter particular investor or entrepreneur data and also to render matching information within the web-based site. The system matches entrepreneur-provided data with funding-provided data based on a set of predetermined matching criteria and thresholds, in order to connect at least one funding/advisory seeker to a plurality of funding/advisory options. The system automatically instantly notifies one or more members of updates with regard to at least one new or modified funding/advisory program, product or service. In another embodiment, the system provides a user-based rating method to facilitate user generated information related to time requirements, return on investment, preference, and ease of use.

### FIELD OF THE INVENTION

The present invention relates to the field of electronic data/information processing. More specifically, the present invention relates to electronic data/information processing methods and systems for matching and managing information in real-time related to funding/advisory seekers and funding/advisory providers and their related funding/advisory programs, services, and products.

### BACKGROUND OF THE INVENTION

With the proliferation of networked digital devices and related content, information is readily available in many different forms on the internet. Similarly, there is a large and growing body of fragmented information on funding/advisory providers and related funding/advisory programs that is available both online and offline. In fact, funding/advisory seekers often rely on search engines; social media networks; compiled lists on CDs, DVDs, or web sites; trusted professional service providers; or other online or offline locations for potential information on funding/advisory programs. It is important to note that when we refer to “program”, we include any specific funding or advisory program, product, or service.

These funding/advisory programs (collectively including funding/advisory providers and their related programs and products) may be designed to fund costs, increase revenue, undertake an operational or strategic initiative, including an acquisition, merger, or sale of a legal entity, or for other economic or non-economic purposes.

Unfortunately, there is no known comprehensive source to not only intelligently identify, but also dynamically tract funding/advisory programs (tax credit, grant, loan, loan guarantee, equity, donation, contest, and advisory service) in a succinct, prioritized single view electronically accessible system.

In the traditional networking model, a broker or agent might learn about an opportunity, and then pass it along to those clients looking for funding programs or advisory programs. The scope and breadth of this informal system is limited by the number of clients and information a particular agent can competently handle.

Since individual information (related to funding programs/products and advisory programs/solutions) brokers have very finite boundaries, information brokerage firms have evolved to contain vast networking bases and resources. Unfortunately, the large information brokerage firms typically charge a substantial fee for their services and do not provide a comprehensive database of funding/advisory programs.

With funding/advisory programs being scattered and strewn on the internet and other places, credibility is at a premium for entrepreneurs looking for financing. A notoriously credible funding/advisory provider might have inefficiencies within a specific funding/advisory program, for instance. Those familiar with the art know that finding a trustworthy endorsement of a financing provider/program and/or advisory program/solution is quite valuable.

Funding/advisory providers can offer programs that will be offered only once, or programs that can be offered to multiple funding/advisory seekers. In the case of tax credits, and to a certain extent grants and others, there is a tendency towards repetition of these programs by different funding/advisory seekers. In such a case, the professional aptitude of a broker or a similar professional's recommendation would be ideal, however these services can be expensive and ultimately cost inefficient.

In the spectrum of fund and advisory seeking, up-to-date information is at a premium. Being able to react towards new funding/advisory programs and alterations to existing funding/advisory programs can be crucial in trying to find an appropriate match. There is generally a time lag between the creation or alteration of a funding/advisory program and the notification towards appropriate funding/advisory seekers in traditional models with which to find funding.

Companies often undertake various activities or projects. These individual projects can be small offshoots of a larger business. These activities will likely require funding. If such an activity is recent, or perhaps based on an opportunity, equity financing can often times not be enough. Finding funding/advisory for these specific activities or programs can be a vital part of a successful business. Simply being matched with an equity provider or similar business partner can be unsatisfactory with regard to operating a successful business.

Many start-up or early stage businesses can have trouble finding appropriate funding or advisory programs. One way in which early stage businesses can get exposure and ultimately succeed is through funding competitions or contests. Funding and/or advisory providers often get together and hold competitions to showcase the best and brightest entrepreneurial ideas.

Prior art known to the applicant is the following:

U.S. Patent Document 2003/0101115 Reddy. This patent relates to an online database application to connect entrepreneurs to investors. This patent restricts itself to venture capital and excludes tax credits and other diverse forms of financing.
U.S. Patent Document 2002/0032599 Chandler et al. This patent relates to a web-centric application that acts as a beacon for entrepreneurs and venture capitalists with an emphasis on community. This patent discusses interaction amongst entrepreneurs and investors, in order to develop an on-line community where businesses can be accelerated.
U.S. Patent Document 2008/0133513 Linde et al. This patent relates to facilitating advertising relationships among various advertising clients and non-profit organizations.
U.S. Patent Document 2003/013412 Monlux et al. This patent relates to the on-line application processes including rate structures used by funding sources. The Monlux embodiment attempts to create an online marketplace through which funding providers may do business with brokers, who in turn do business with their clients with regard to finding funding.
U.S. Patent Document 2003/0014373 Perge et al. This patent relates to the level of privacy for a profile template for a presenter seeking funding. In the Perge invention, a relatively anonymous database system matches business partners together with regard to financing. The system defines a goodness of fit test, and attempts to match appropriate business partners. The database is restricted to fetching information and does not provide browsing or filtering functionality. The disclosed invention simply matches partners together, having no focus on project orientation or on changing business circumstances.
U.S. Pat. No. 5,774,883 Andersen et al. This patent discloses a method for selecting a seller's most profitable financing program. This patent discloses a transaction management system and method for validating the sale of an asset. The system is used to evaluate credit risk, and find the optimal financing solution for the sale/purchase of an asset. This patent mainly focuses on the financing aspect of an asset. No information about alternative forms of financing, or alternative projects or items that require financing are provided by the system.

### SUMMARY OF THE INVENTION

The initial objective of the invention is to systematically and automatically gather at least one funding/advisory program using at least one inputting mean such as algorithms that automatically identify, process, and input funding/advisory programs, manually inputted funding/advisory programs including those from trusted third parties. The system simultaneously gathers all the funding and advisory programs for funding/advisory seekers.

Within the scope of the present invention, a funding/advisory program should be defined as collectively including funding and advisory entities and their related programs and products. Such programs comprise tax credits, grants, loans, loan guarantees, equity funding, contests, donations, and advisory services.

The data collection and organization may rely on at least one parameterized funding/advisory criterion specified by funding/advisory providers for each program, product or services such as but not be limited to a) primary funding/advisory criteria such as but not limited to funding/advisory seeker location, year of incorporation, industry/industries, legal ownership type, age of controlling shareholders, number of full time employees, revenues in the last year, fiscal year end; and b) secondary funding/advisory criteria such as including but not limited to funding/advisory seeker interests in and focus on certain business areas of operation, exporting, equipment purchasing/leasing, energy optimization, product development, product modification, collaborative development, hiring of interns with certain levels of education and/or for a certain term, hiring of full time employee, hiring of contractor, training of employee, strategic transaction, and finally undertaking a new project with a certain length, cost, or creating certain jobs. The system comprises dynamic threshold limits for establishing funding/advisory criterion for each individual funding/advisory program or for each group of funding/advisory programs, as the case may be. The system allows the reliability of the matching process to increase based on the input of additional information criteria.

Funding/advisory seekers may input at least one primary/secondary funding/advisory criterion or specify at least one direct electronic data interchange connection setting. The system uses at least one criterion and at least one connection setting to display the matching current and relevant funding/advisory programs. At least one criterion shall not be expected to be modified regularly. However, at least one secondary funding/advisory criterion and other criteria or settings may be changed in real-time depending on at least one business constraint, interest and plan.

The system displays the results based on the at least one criterion inputted by the funding/advisory seeker. The results are displayed as a comprehensive and unified combination of all funded and currently available funding/advisory programs including tax credits, grants, loans, loan guarantees, equity funding, contests, donations, and advisory services at any time in any place through any device or medium and with dynamically changing business constraints, interests, and plans.

The display of the results may be presented as a succinct, complete, or partial view and may be sorted and prioritized. The view may comprise a comprehensive, unified, and detailed view of the currently available and funding/advisory programs based on the at least on criterion inputted by the funding seeker; or may comprise a combination of the at least one current funding/advisory seeker funding/advisory criterion and the matching comprehensive, unified, and detailed view of the currently available and funded funding programs and advisory programs. The unified view may comprise fields related to programs such as description, program funding/advisory area, program sponsor, eligible expenditures, amount or percentages, program description, web links, and other information.

The system may allow a funding/advisory seeker to store and manage at least one simultaneous unified view for each different situation and/or entity.

Moreover, the system may enable the funding/advisory seeker to begin the application process for one or several funding/advisory programs based on the information provided by way of the information available from at least one information source such as the primary, secondary, data interchange, or other information sources, or from additional information provider by the funding/advisory seeker.

The system may allow a user to apply to such a funding/advisory program through a third party or the funding/advisory seeker may track and manage the application process through an electronic system, a paper form that may be submitted through a communication mean such as mail or fax or a combination of a plurality of media portal systems that would allow an efficient, automated, and complete exchange of information between funding/advisory seekers and funding/advisory providers.

The system may also comprise a rating system. Such rating system may comprise a social and communicative mean. At least one funding/advisory seekers having experienced a specific funding/advisory program may rate the program using the system. The rating system may use an algorithm based on time required weighting, return on investment, preference, and ease of use to process the rating. The rating could indicate to other funding/advisory seekers the strength and sensibility of different funding/advisory programs and help such seekers to select the right program.

As a point of differentiation, an embodiment of the invention focuses on alternate sources of funding/advisory outside of equity and investor financing such as tax credits, grants, and the like. Such alternate sources are included in a datasource. Many programs documented will be ongoing and consistent across various users. Because of this point of differentiation, a rating system is quite valuable to users of this embodiment for identifying the funding/advisory providers/programs that are of high quality. As well as these funding/advisory programs, the system may make use of and store funding contests within the datasource.

The system and method described herein allow funding seekers to be constantly updated when looking for funding. As new programs come out quite often, this invention discloses a process through which members are automatically and instantly updated whenever a new program is added, removed or changed in the database following an approval process.

The disclosed system and method focus on activity, project and situation oriented funding. With companies needing to accomplish activities and projects, and overcome specific situations, the ability to simultaneously browse only relevant and preferably matching funding/advisory programs is certainly valuable. This invention allows the matching of business partners and simultaneously matches funding/advisory seekers' activities, projects, or situations with particular funding/advisory programs or products. This method increases the interactivity of the system and provides to funding/advisory seekers more flexibility when looking for funding.

The filtering capabilities of the system allow to dynamically find funding/advisory programs. According to different projects, activities, or situations; a funding/advisory seeker may change the filtered information and search the datasource accordingly. The system displays the matching results and allows clients to browse the matching results. The increased visibility for funding/advisory providers represents a major feature of the system.

Within the scope of the present invention, a funding/advisory seeker is defined as an entity looking for funding or advisory program, product, or services in order to accomplish pre-specified goals. The entity may represent a privately held corporation or any other entity that would require funding or advisory services for various activities, projects or situations.

Also, a funding/advisory provider is defined as an entity looking to provide funding or providing their advisory services such as a corporation, a not-for-profit organization, an individual or a public entity such as the government that is looking for an appropriate match for funding.

A primary criterion for funding/advisory seekers relates to the overall nature and condition of the funding/advisory seekers business. The primary criterion provided in a company profile for funding/advisory seekers is indicative of the general nature of the business. A secondary criterion, in contrast, is defined as the criterion representing the project, activity, or situation oriented goals of the funding/advisory seeker.

Within the scope of this invention, a funding/advisory program includes a tax credit, grant, loan, loan guarantee, equity offering, advisory service, advisory product, or advisory service that is aimed at funding or advising with a project, activity, situation, or business interest of a funding/advisory seeker. A program may be oriented toward businesses, educational purposes, non-profits, or other purposes such as research by universities.

The features of the present invention which are believed to be novel are set forth with particularity in the appended claims.

Understandably, other advantages and novel features of the present invention will be obvious upon an understanding of the illustrative embodiments about to be described by reference to the following detailed description and considered in connection with the accompanying drawings in which like reference symbols designated like elements throughout the figures.

### BRIEF DESCRIPTION OF THE DRAWINGS

The above and other objects, features and advantages of the invention will become more readily apparent from the following description, reference being made to the accompanying drawings in which:

FIG. 1 is a pictorial representation of a computer system, which may be utilized to implement a preferred embodiment of the present invention;

FIG. 2 is a diagram of a client-server architecture, in accordance with a preferred embodiment of the present invention;

FIG. 3 is a flowchart illustrating the method to manage information related to at least one program or product.

FIG. 4 is a flowchart illustrating the method for seeking funding/advisory information.

FIG. 5 is a flowchart illustrating the process for new funding/advisory providers and seekers.

FIG. 6 is an example of a graphical user interface presenting the primary funding/advisory criteria related to the company profile.

FIG. 7 illustrates an example of a graphical user interface presenting the secondary funding/advisory criteria related to the operational profile and product development.

FIG. 8 illustrates an example of a graphical user interface presenting the secondary funding/advisory criteria related to parameters of the hiring and training, strategic transaction, and project.

FIGS. 9A and 9B illustrate an example of a graphical user interface to gather information from funding/advisory providers for a grant such as: general information, program parameters and eligible recipients;

FIGS. 10A and 10B illustrate an example of a graphical user interface to gather information from funding/advisory providers for a grant such as: funding benefits, funding limits and additional information.

FIGS. 11A and 11B illustrate an example of a graphical user interface to gather information from funding/advisory providers for tax credits such as: general information, program parameters and eligible recipients.

FIG. 12 illustrates an example of a graphical user interface to gather information from funding/advisory providers for tax credits such as: funding benefits, funding limits and additional information.

FIGS. 13A and 13B illustrate an example of a graphical user interface to gather information from funding/advisory providers for loans such as: general information, program parameters and eligible recipients.

FIG. 14 illustrates an example of a graphical user interface to gather information from funding/advisory providers for loans such as: funding benefits, funding limits and additional information.

FIGS. 15A and 15B illustrate an example of a graphical user interface to gather information from funding/advisory providers for loan guarantees such as: general information, program parameters and eligible recipients;

FIG. 16 illustrates an example of a graphical user interface to gather information from funding/advisory providers for loan guarantees such as: funding benefits, funding limits, and additional information.

FIG. 17 illustrates an example of a graphical user interface to gather information from funding/advisory providers for equity such as: general information, program parameters and eligible recipients.

FIG. 18 illustrates an example of a graphical user interface to gather information from funding/advisory providers for equity such as funding limits and additional information.

FIG. 19 illustrates an example of a graphical user interface to gather information from funding/advisory providers such as: general information, advisory parameters, eligible recipients, advisory benefits, strategic transactions, project, and additional information.

### DETAILED DESCRIPTION OF THE PREFERRED EMBODIMENT

A novel system and method for interactive identification and matching of funding/advisory seekers and funding/advisory providers or their programs/products will be described hereinafter. Although the invention is described in terms of specific illustrative embodiment(s), it is to be understood that the embodiment(s) described herein are by way of example only and that the scope of the invention is not intended to be limited thereby.

The present embodiment may automatically bring together and combine funding/advisory programs using inputting means such as 1) algorithms that automatically identify, process, and input funding/advisory programs, 2) manually inputted funding/advisory programs by funding/advisory providers and 3) manually inputted funding/advisory programs, products or services from trusted third parties. This information shall then be sorted as complete or incomplete by the system. Based on the sorting result, this information would then be combined to allow funding/advisory seekers to identify funding/advisory programs in an interactive, real-time system.

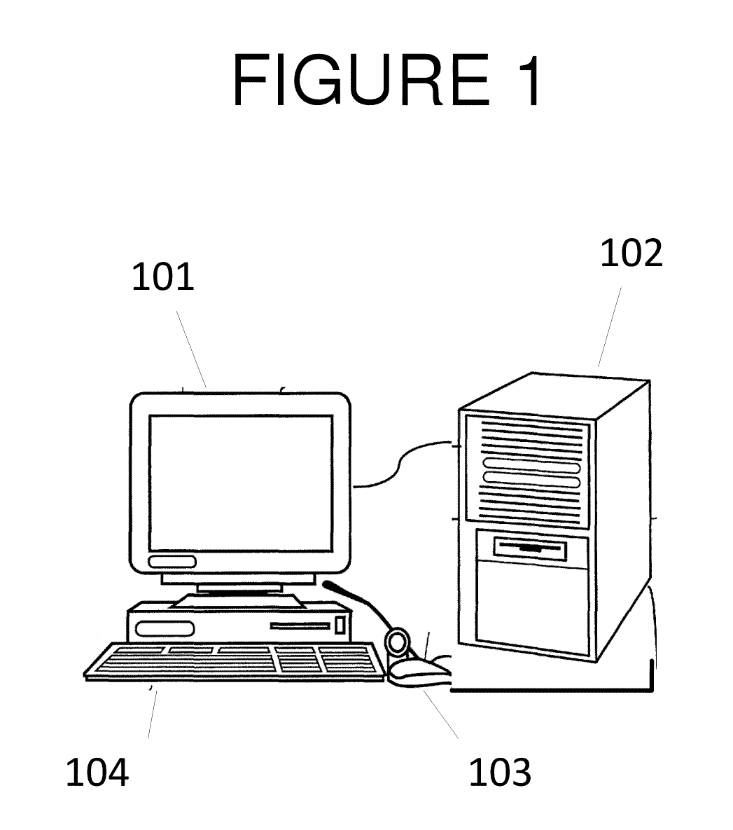

Referring to FIG. 1, a device is used to access the system, such as a desktop or laptop computer, a smart phone or device or any other client device, such device comprising a system unit (102), a video display apparatus, such as a terminal (101) or a screen, a human to machine interface such as a keyboard (104), a mouse (103), a touch screen interface or any other human to machine interface. Those skilled in the art will appreciate that the method and system of the present invention apply equally to any device, regardless of whether the device is generally implemented as a complex multi-user computing apparatus or a single-user workstation.

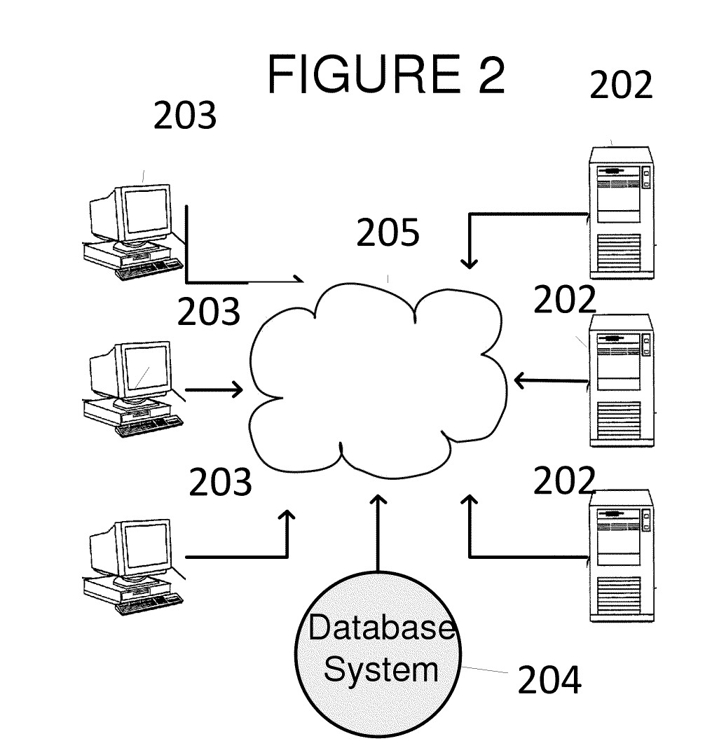

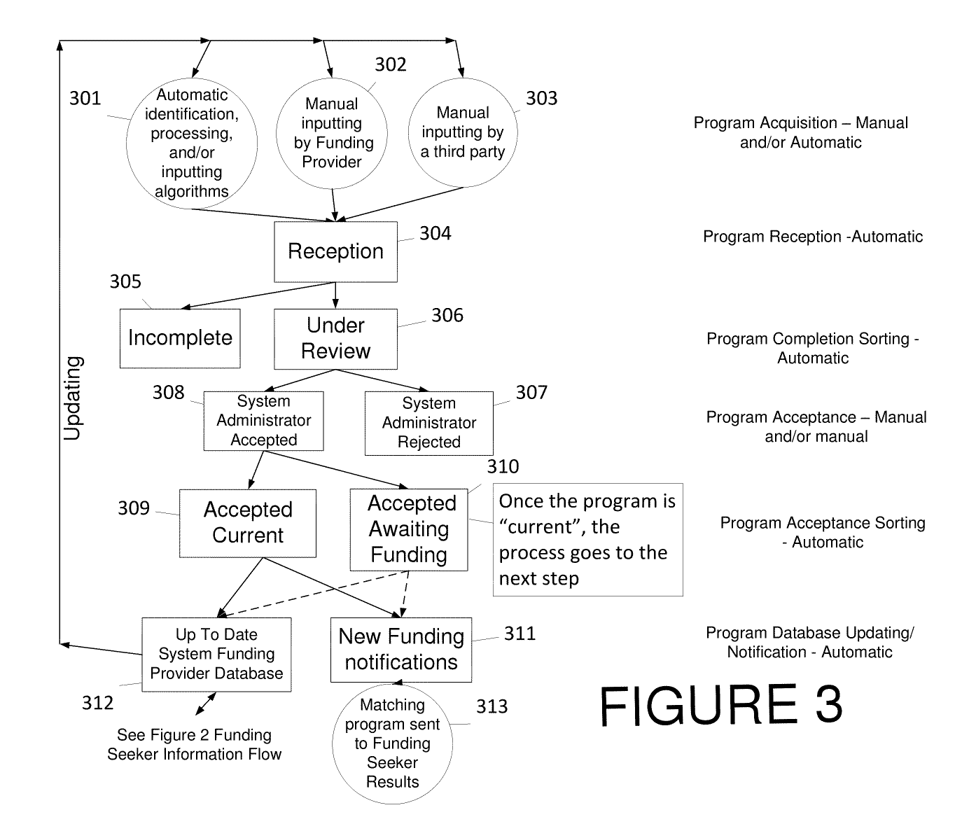

Now referring to FIG. 2, the client/server architecture of the system for interactive identification and matching of funding/advisory seekers and funding/advisory providers or their programs/products is presented. The system comprises at least one server (202), at least one storage service (204) such as a database system, an XML file, a binary file or any type of organized data storage and at least one client device (203) such as a desktop or laptop computer, a terminal, a smart phone or any other client device. The server (202) may comprise an application server, a web server and a controller and may access the storage service (204) and the client device (203) through a computer network (205) such as a wide area network (WAN), the Internet, a local area network (LAN), a central cloud setup or any type of networked devices. The storage service is organized to persist the programs related to the matching criteria. In another embodiment, at least one server (202) and at least one data source (204) may be present on the same physical computer or machine.

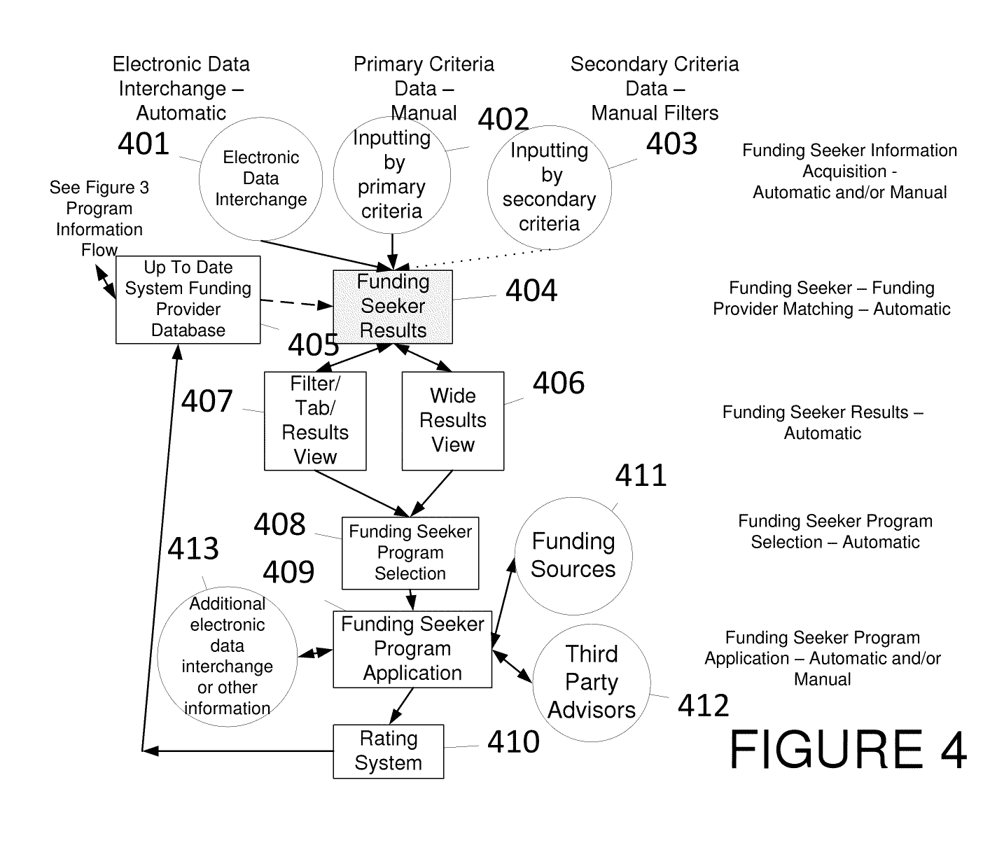

Now referring to FIG. 3, the method for updating the program related information is shown. Still referring to FIG. 3, the method presents the steps for a user with privileged access, such as an administrator user or a power user, to update program related information through a graphical interface. The method comprises the steps for inputting program related information into the system (301, 302, 303), for the system to receive inputted program related information (304), for validating the inputted program related information (305 and 306), for user with privileged access to accept or reject the inputted information (308 and 309), for classifying the validated program information and to store the updated program related information (311, 312, 313). The step for inputting program related information into the system (301, 302, 303) may be realized by an automatic identification, processing, and/or inputting algorithms (301), by manual inputting by the funding/advisory provider (302), or by manual inputting by a third party (303).

The following step provides a mean for the system to receive the inputted related information (304). Using a graphical user interface, a user with privileged access may add at least one program into a waiting area. The waiting area stores the at least one new program in a memory space. A user with privileged access must validate the at least one program. On validation, the system moves the at least one program to the main datasource.

Next, after receiving the inputted related program information, the system validates the information as either incomplete (305) or under review (306). The program classified as incomplete shall be stored within a different datasource, such as a hidden database or any other file. The incomplete program may remain available for editing. A program shall only be deemed incomplete if the system determines that not enough information was provided for the program. To determine if enough information was provided, the system may use rules such as ensuring that enough information is present for indexation.

Then, in the event where the preceding step (305, 306), validates the information as under review (306), the system administrator will either reject (307) or accept the program (308) and will classify the program as either current (309) or awaiting funding (310). The system may label as “awaiting funding” any program being currently closed or not available but having been available or that will be available again in the future. When the system labels a program as “awaiting funding”, such program may bestored within a datasource not accessible to user without privileged access, such datasource may be a separate database or may be included within the main datasource. The classification step may be executed manually, by the third party funding/advisory provider or through any automatic computer algorithm or system.

The following step is triggered when a funding/advisory program has been classified as current (309). The last step stores the inputted program related information within the up to date funding/advisory provider database (312). Such classification may executed manually by a privileged user, by a third party funding/advisory provider or through an automatic computer algorithm or system. Additionally, the system may create and store at least one new funding/advisory notification (311). A funding/advisory notification allows a potential matching program to be sent to funding/advisory seeker results (313). The system sends a notification, such as an email, a phone call, a SMS or any notification through a communication means such as the Internet, a mobile or landline network, if a change to an existing funding/advisory program is triggered or if an old funding/advisory program has been modified.

Now referring to FIG. 4, the method for obtaining program information and details is presented. The method allows a funding/advisory seeker user, such as an entrepreneur or a non-profit organization to select the criteria for filtering the different programs that match the needs of the user.

Still referring to FIG. 4, the method comprises a plurality of steps allowing funding/advisory seeker users to find matching programs. Such steps comprise inputting the funding/advisory seeker information, matching the funding/advisory seekers needs to appropriate programs, viewing the matching results, filtering the matching results, selecting at least one appropriate program, applying for a program, and preferably rating the selected program. The step for inputting the funding/advisory seeker information may be executed by automatic communication means (401) such as electronic data exchange (401), XML file or other standardized communication mean, by the funding/advisory seeker user inputting at least one primary criterion or t (403) through an human-machine interface such as graphical user interface, or by the funding/advisory seeker user inputting secondary criteria (403). Then, the step matching the funding/advisory seekers needs to one or more appropriate program uses the inputted criteria as parameters to an algorithm that fetches matching program results within the data source. The system displays the resulting programs on the client devices (404) through the method described hereinabove and presented in FIG. 1.

Next, the system allows the funding/advisory seeker user to filter the matching results (407). The system may also display an unfiltered wide results list (406). Within the matching programs displayed by the system, the funding/advisory seeker user may select a program (408) and may request to apply (409) through an electronic communication mean such as electronic data interchange (413), through at least one third party adviser (412), or through the funding/advisory providers themselves (411). The application process may also be completed manually through an external system. After having applied for a program, a user may be requested by the system through a communication mean such as a graphical interface window, an email or a notification, to rate the program application process. On such request, the system may output the results of the program application to a rating system (410). The rating results are stored within the system datasource in order to maintain up to date system funding/advisory provider datasource (405).

In another embodiment, the rating system output may be used as a social and feedback oriented parameter when filtering the programs through the datasource.

In another embodiment, the system shall provide a automated means for completing business transactions for the application process (409).

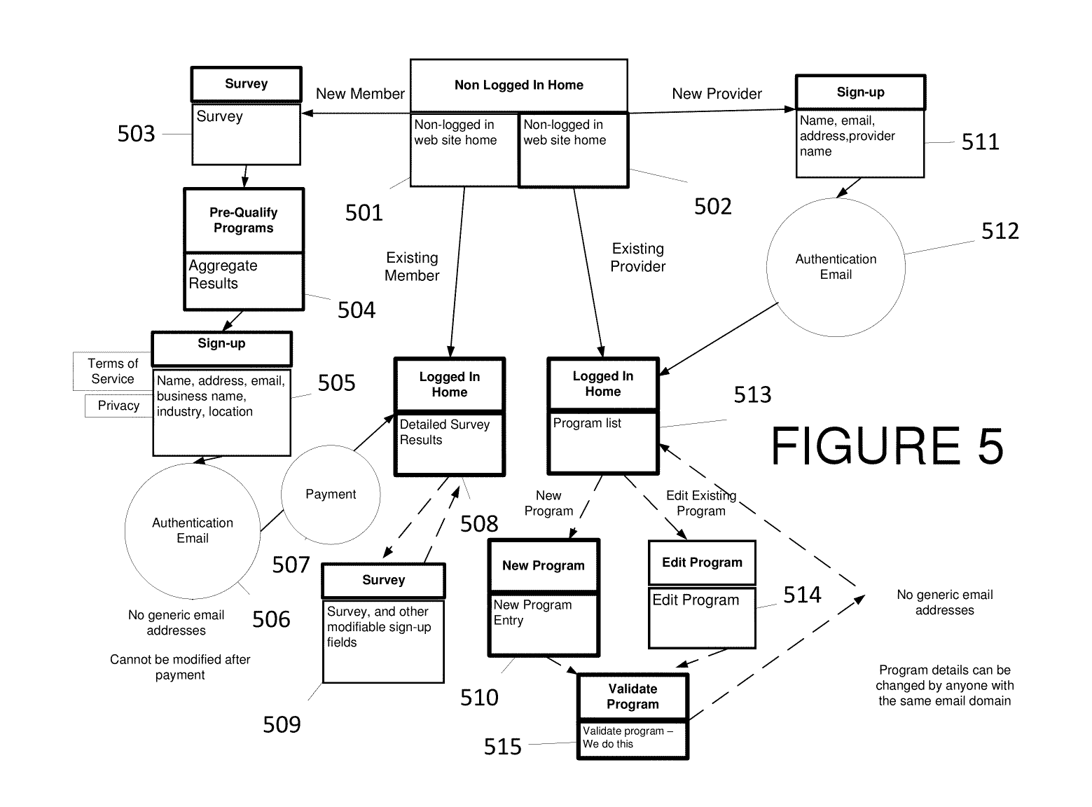

Now referring to FIG. 5, a method for funding/advisory seekers and providers to navigate through the system is presented. The method comprises a plurality of steps for allowing navigation for funding/advisory seekers and providers, such as registering a new user to the system, authenticating a user to the system, inputting at least one criterion related to the funding/advisory seeker user funding/advisory needs, updating program information, creating new program information and validating program related information.

Any user, such as a funding/advisory seeker user or a funding/advisory provider user, accessing the system is redirected to public central access point (501), such as a web site home page or a welcome interface. The public central access point comprises a pre-qualification process, a registration means and a logging means.

The pre-qualification process allows a new funding/advisory seeker user to filter, browse and consult aggregate results (504) that displays basic program related information. The basic program related information may include the number of matching program, the category of the funding/advisory program, the amount of money related to the program or any other information related to a program.

The system allows a new user to register to the system through the registration means (505). The registration means requires the new user to submit profile information, such as email address and name of the organization and primary criteria. On submission of the information to the system, the system sends an authentication notification to the user (506), such as an email, a SMS or any other electronic notification means. To be authenticated, the user must confirm the reception of the authentication notification. The confirmation may be executed by the user clicking on a link comprised within the authentication notification. The user being authenticated, the system may present a payment interface (507) and require the user to provide a payment. Such payment interface may be automatic, such as entering a credit card number, using external payment system such as PayPal™, or may request the user to send the money manually, such as sending a check by mail or using a bank transfer.

The system allows a registered funding/advisory seeker user to log in to the system through the logging means. The logging means requires the registered funding/advisory seeker user to input his credential information, such as a user name and a password. The system validates the credential information. If the credential information is valid, the user is forwarded to a private central access point, such as web site home page accessible only to registered or privileged users (508).

Any funding/advisory seeker user may browse the matching results and modify the primary and secondary criteria associated to their profile (509).

Any funding/advisory provider user may create a new program (510) or edit an existing program (514) through a graphical user interface following the method to update program related information presented in FIG. 3 (515).

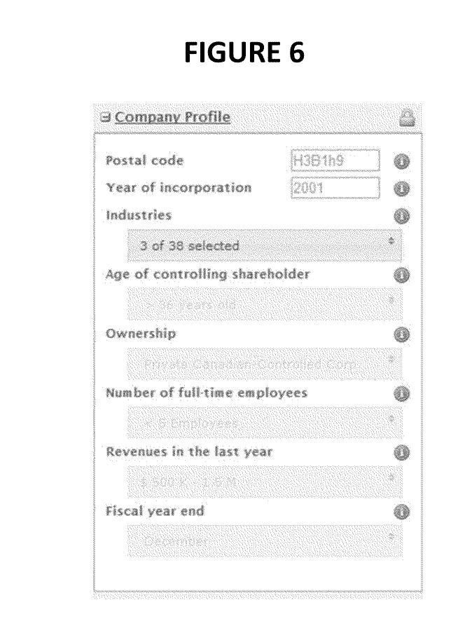

Now referring to FIGS. 6, 7 and 8, the primary criteria for funding/advisory seekers are presented.

Now referring to FIG. 6, the system allows a funding/advisory seeker user to filter the program through at least one company profile criterion. A company profile criterion comprises information related to the company or organization of the funding/seeker such as postal code, year of incorporation, industry areas, age of controlling shareholder, ownership, number of full-time employees, revenues in the last year, and fiscal year end.

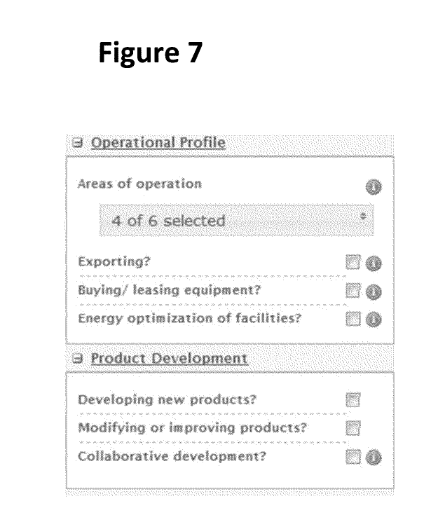

Now referring to FIG. 7, the system allows a funding/advisory seeker user to filter the program through at least one operational profile criterion such as areas of operation, options for exporting, buying/leasing equipment, and energy optimization of facilities. Still referring to FIG. 7, the system allows a funding/advisory seeker user to filter the program through at least one product development such as options for developing new products, modifying or improving products and collaborative development.

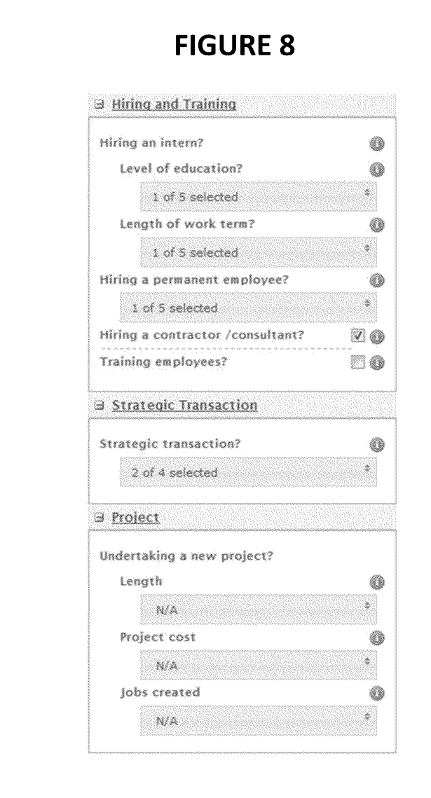

Now referring to FIG. 8, the system allows a funding/advisory seeker user to filter the program through at least one criterion for fund seekers related to hiring and training, strategic transaction, and project. The hiring and training criterion may comprise information concerning interns and permanent employees, contractors, consulting and training. A criterion related to a strategic transaction project may comprise strategy and the undertaking of new project.

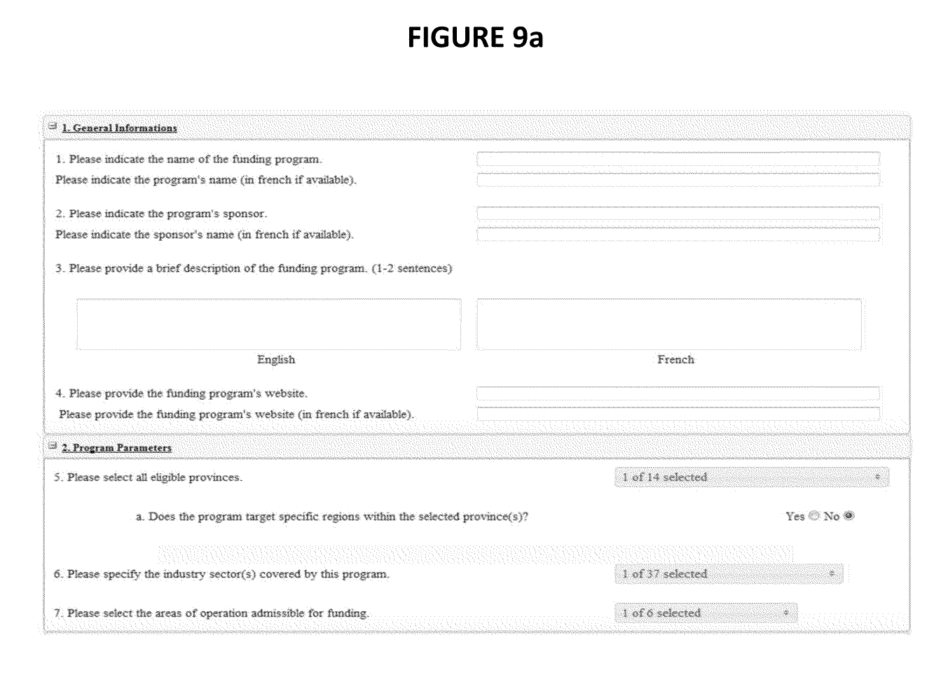

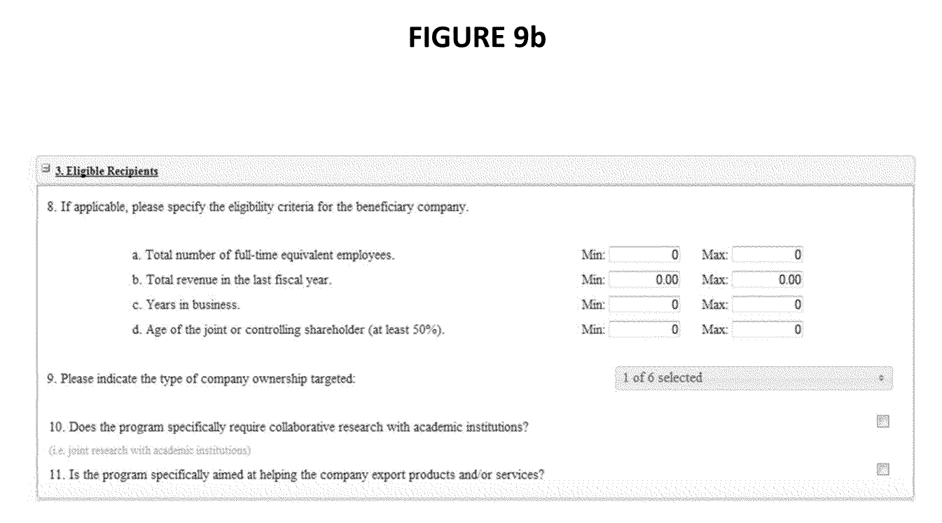

Now referring to FIGS. 9 to 19, some secondary criteria for funding/advisory seekers are presented.

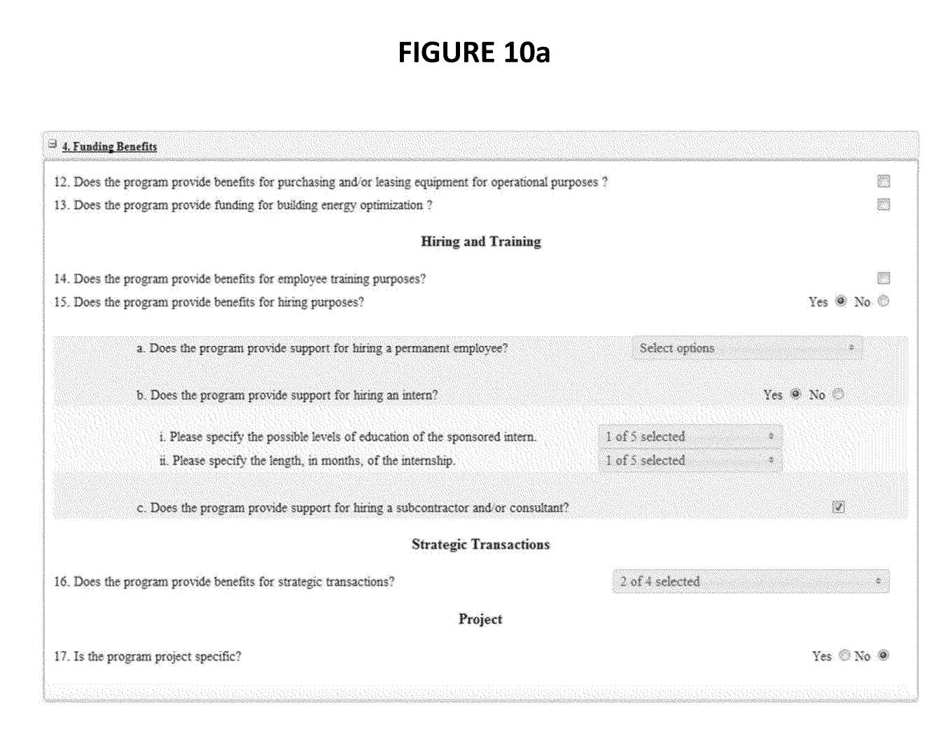

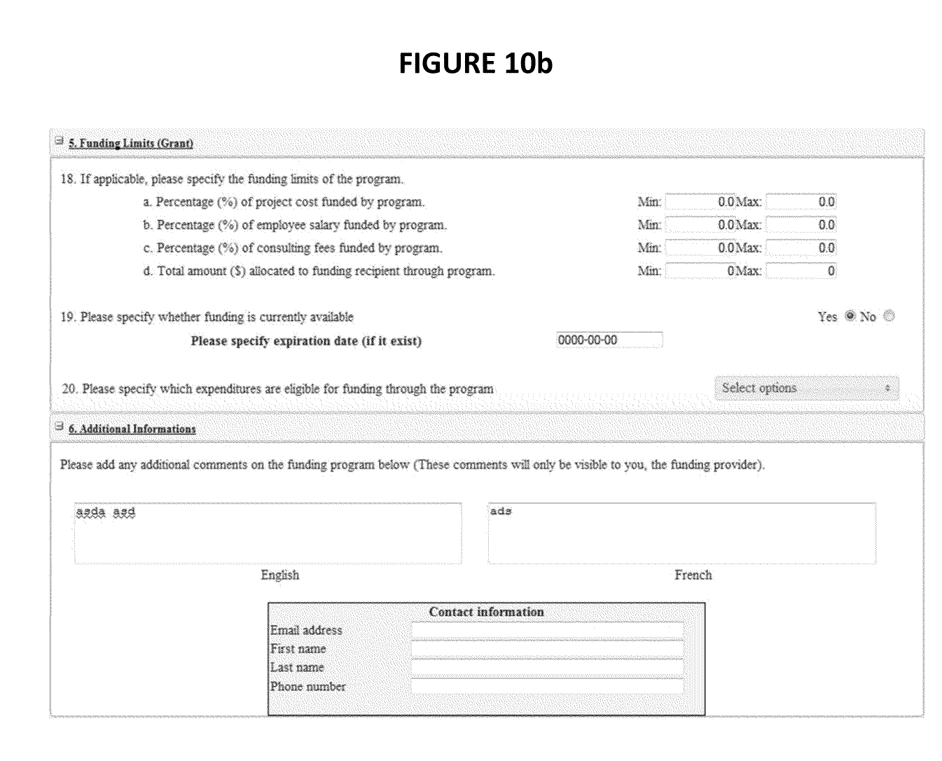

Referring now to FIGS. 9A, 9B, 10A and 10B, the system allows a funding/advisory seeker user to filter the program through at least one criterion for funding/advisory providers regarding grants. A criterion related to general information may comprise the name of the funding/advisory program, the program's sponsor, a brief description of the funding/advisory program and the funding/advisory provider's website. A criterion related to program parameters may comprise selecting all eligible provinces, specification of the industry sector(s) covered by this program, and selection of the areas of operation admissible for funding. A criterion related to eligible recipients may comprise specification of the eligibility criteria for the beneficiary company, such as the total number of full-time employees, total revenues in the last fiscal year, years in business, age of the joint or controlling shareholder. A criterion related to eligible recipients may also comprise the type of company ownership, specification of collaborative research with academic institutions and specification of aim at helping the company export products and/or services. A criterion related to funding benefits may comprise provision of benefits for purchasing and/or leasing equipment for operational purposes, provides of funding for building energy optimization, provision of benefits for employee training purposes, provision of benefits for hiring purposes, provision of benefits for strategic transactions, and provision of program specificity. A criterion related to funding limits may comprise percentage of project cost funded by program, percentage of employee salary funded by program, total amount allocated to funding recipient through program, when the funding is currently available, and specificity with regard to which expenditures are eligible for funding through the program. Additional information includes any additional comments on the funding/advisory program, as well as contact information.

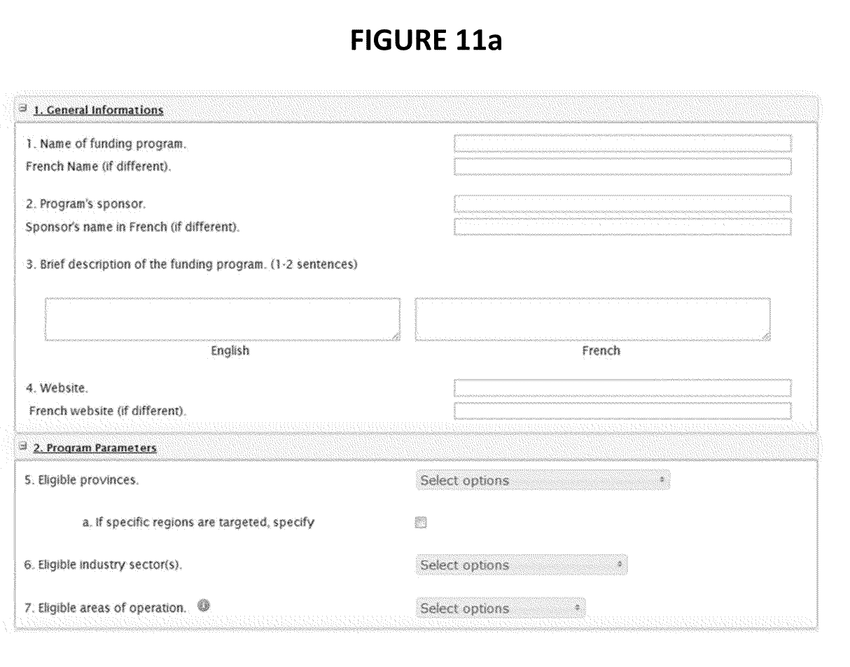

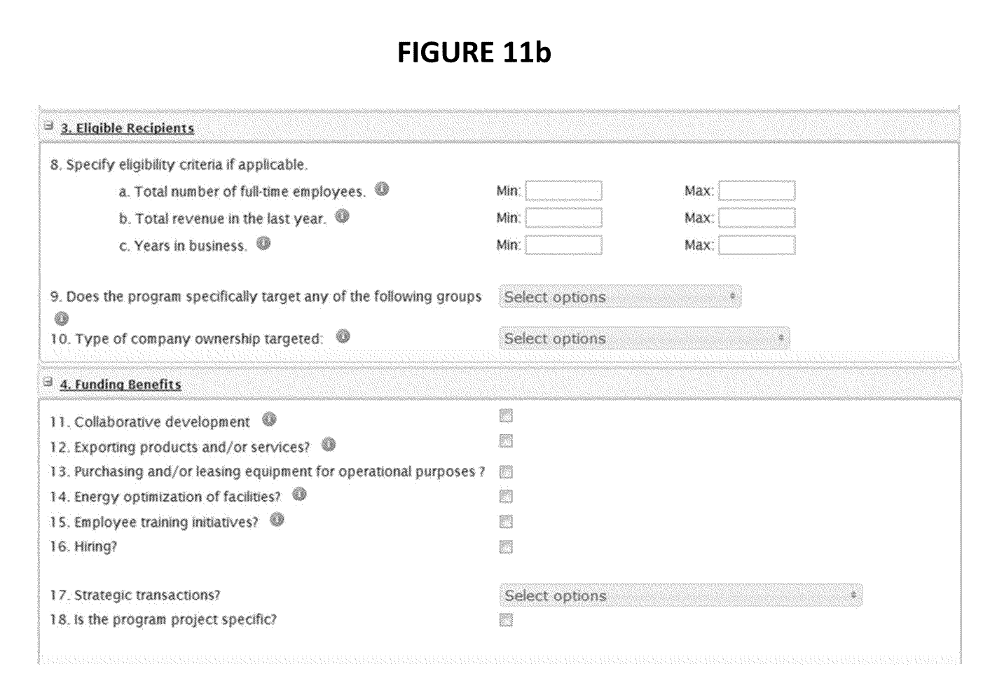

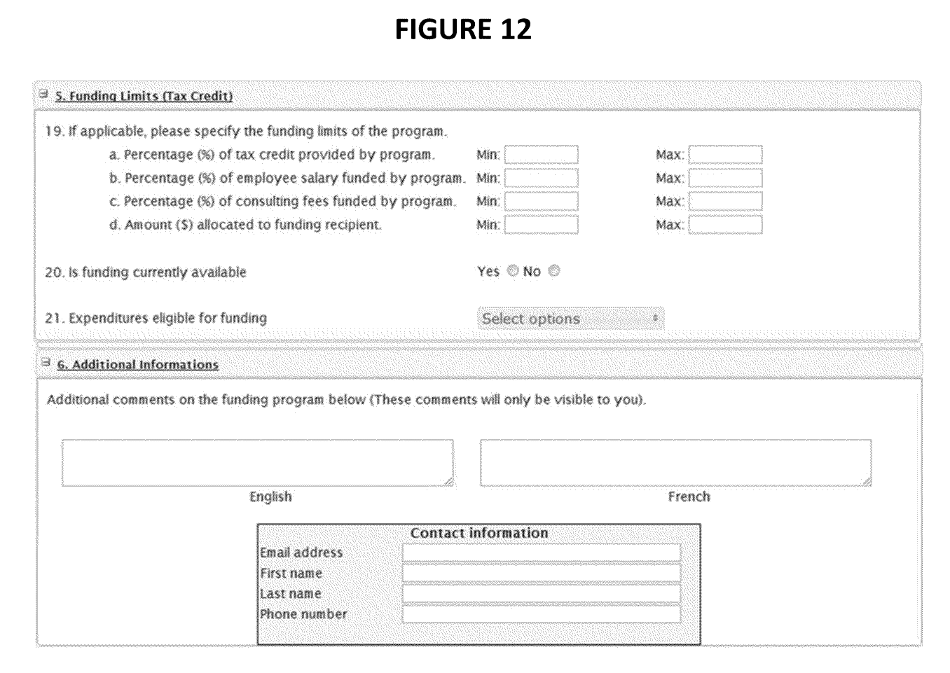

Referring now to FIGS. 11A, 11B and 12, the system allow the filtering of programs through at least one criterion required for funding/advisory providers with regard to tax credits. A criterion related to general information may comprises the name of the funding/advisory program, the program's sponsor, a brief description of the funding/advisory program, and the funding/advisory provider's website. A criterion related to program parameters may comprise selecting all eligible provinces, specification of the industry sector(s) covered by this program, and selection of the areas of operation admissible for funding. A criterion related to eligible recipients may comprise specification of the field of activity, specification of group targeting, type of company ownership targeted and at least one eligibility criterion for the beneficiary company, such as total number of full-time employees, total revenues in the last fiscal year, years in business. A criterion related to funding benefits include collaborative development, exporting products and/or services, purchasing and/or leasing equipment for operational purposes, energy optimization of facilities, employee training initiatives, hiring, strategic transactions and the specificity of the project. A criterion related to funding limits may comprise percentage of tax credit provided by program, percentage of employee salary funded by program, percentage of consulting fees funded by program and amount allocated to funding recipient, if the funding is available and expenditures eligible for funding. A criterion related to additional information may comprise any additional comments on the funding/advisory program, as well as contact information.

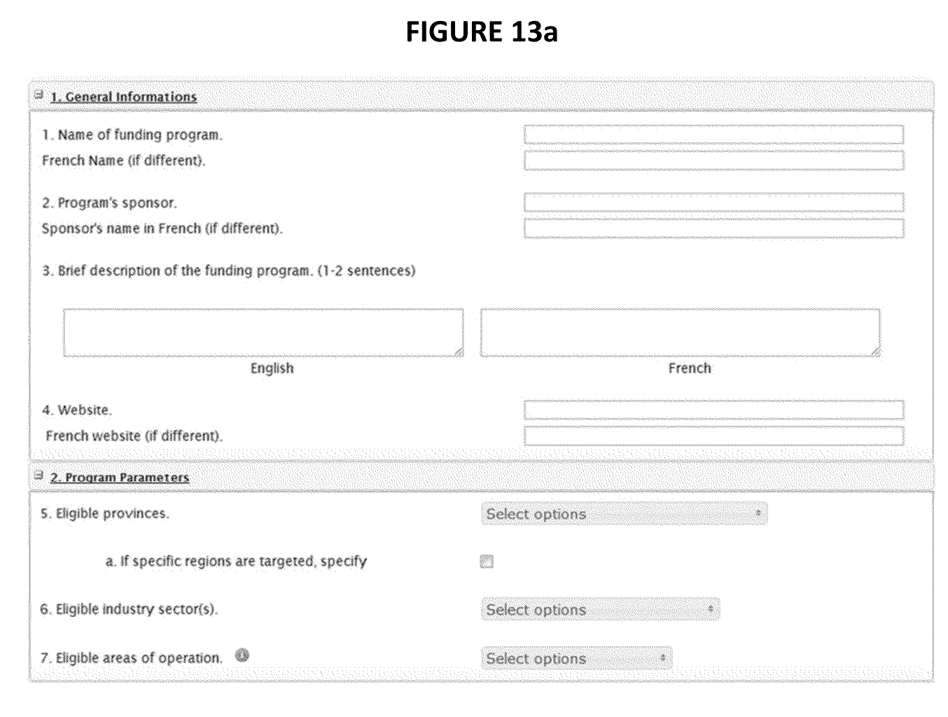

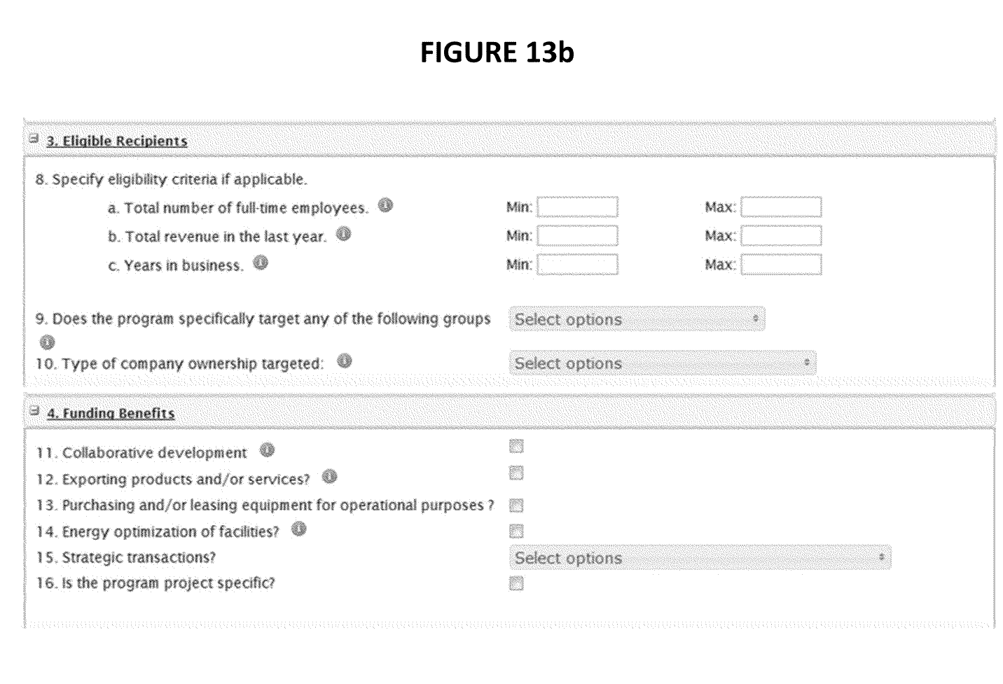

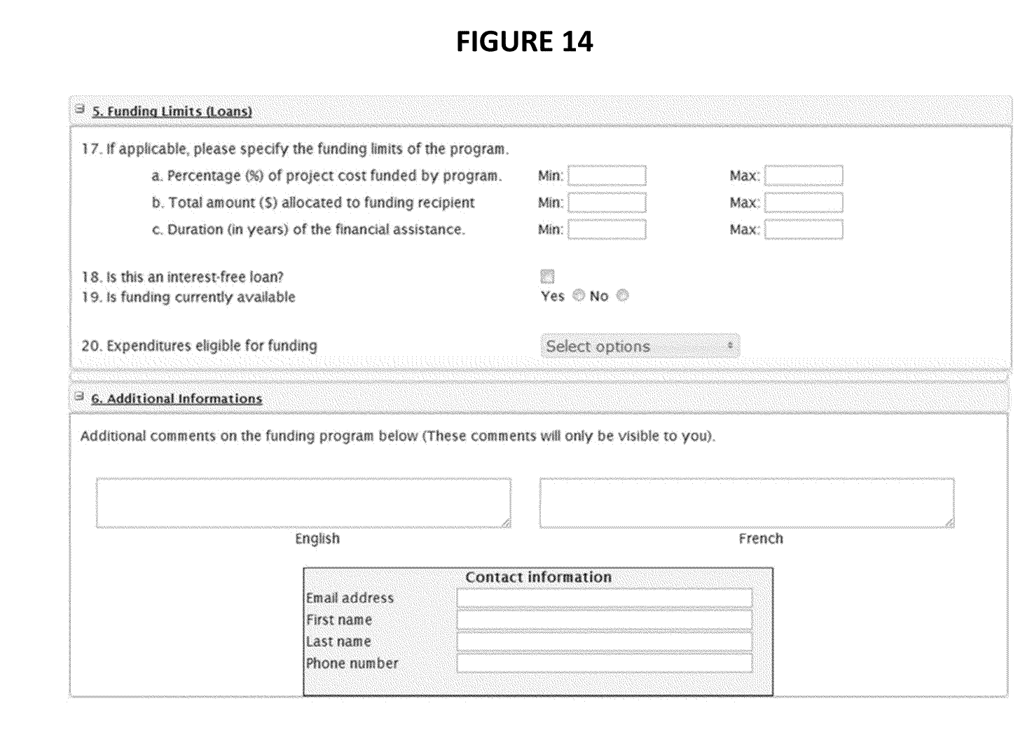

Referring now to FIGS. 13 and 14, the system allow the filtering of programs through at least one criterion required for funding/advisory providers with regard to loans. A criterion related to general information may comprise the name of the funding/advisory program, the program's sponsor, a brief description of the funding/advisory program and the funding/advisory provider's website. A criterion related to program parameters may comprise selecting all eligible provinces, specification of the industry sector(s) covered by this program, and selection of the areas of operation admissible for funding. A criterion related to eligible recipients may comprise the fields of activity, specification of target groups, specification of the type of company ownership targeted and specification of the eligibility criteria for the beneficiary company such as total number of full-time employees, total revenues in the last fiscal year, years in business. A criterion related to funding benefits may comprise collaborative development, exporting products and/or services, purchasing and/or leasing equipment for operational purposes, energy optimization of facilities, strategic transactions, and the specificity of the project. A criterion related to funding limits may comprise percentage of project cost funded by program, total amount allocated to funding recipient, and duration of financial assistance, question of interest free or not, is the funding currently available, and the expenditures eligible for funding. A criterion related to additional information may comprise any additional comments on the funding/advisory program, as well as contact information.

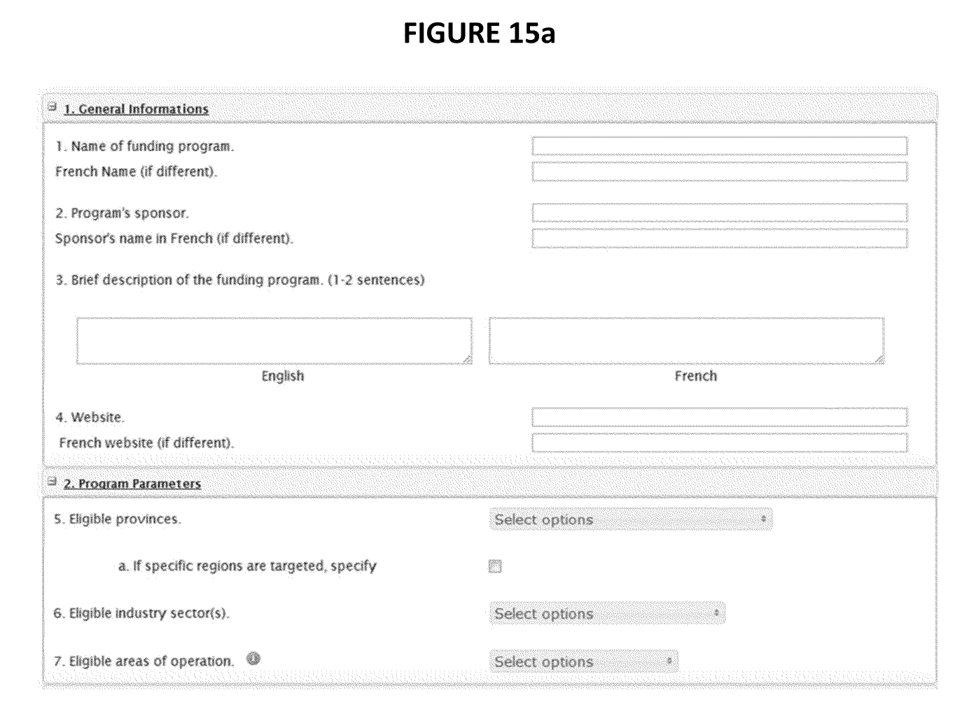

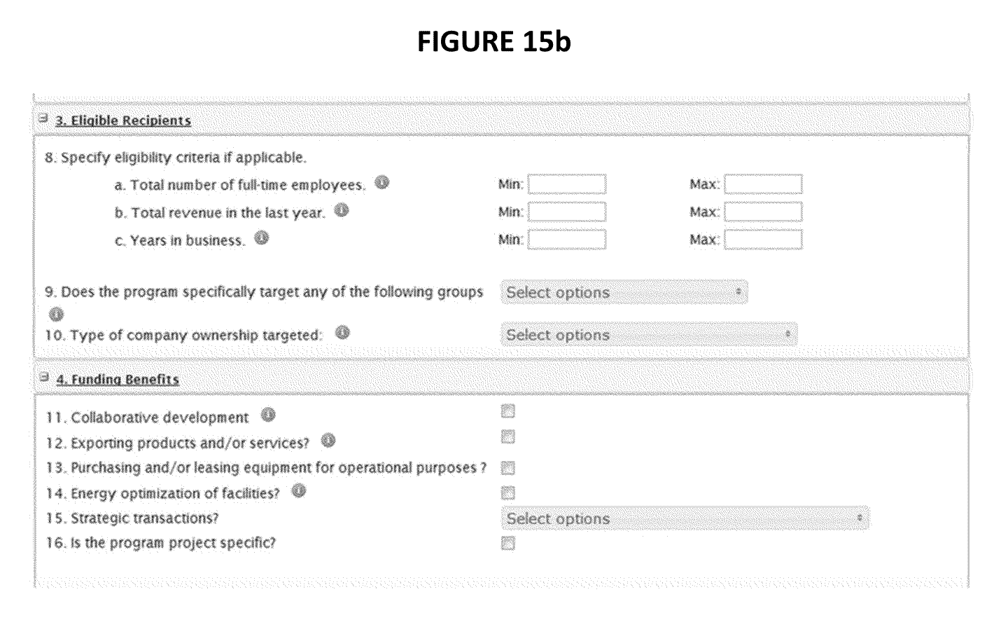

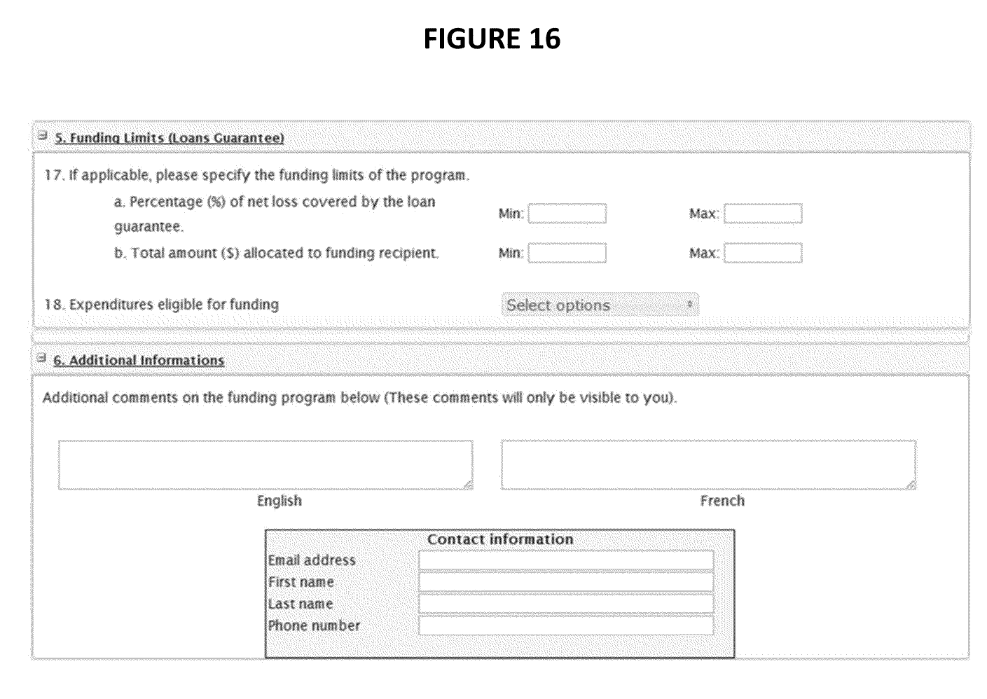

Referring now to FIGS. 15 and 16, the system allows the filtering of programs through at least one criterion required for funding/advisory providers with regard to loan guarantees. A criterion related to general information may comprise the name of the funding/advisory program, the program's sponsor, a brief description of the funding/advisory program and the funding/advisory provider's website. A criterion related to program parameters may comprise selecting all eligible provinces, specification of the industry sector(s) covered by this program and selection of the areas of operation admissible for funding. A criterion related to eligible recipients may comprise the fields of activity, specificity of group targets, the type of company ownership targeted and specification of the eligibility criteria for the beneficiary company such as the total number of full-time employees, total revenues in the last fiscal year, years in business. A criterion related to funding benefits may comprise collaborative development, exporting products and/or services, purchasing and/or leasing equipment for operational purposes, energy optimization of facilities, strategic transactions, and is the program project specific. A criterion related to funding limits may comprise the percentage of net loss covered by the loan guarantee, total amount allocated to funding recipient, and expenditures eligible for funding. A criterion related to additional information may comprise any additional comments on the funding/advisory program, as well as contact information.

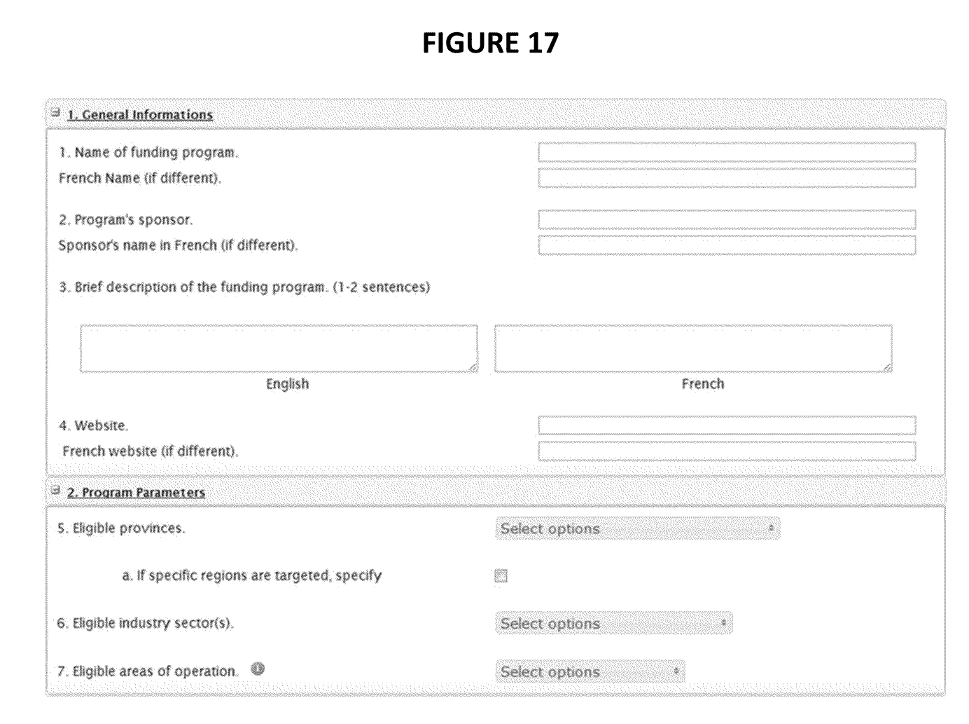

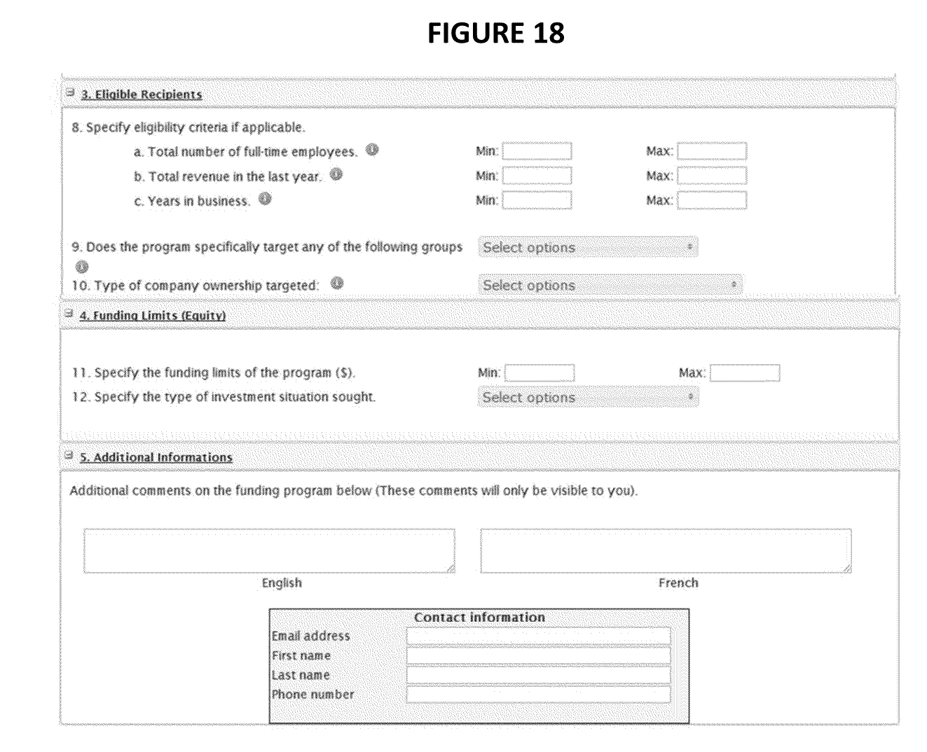

Referring now to FIGS. 17 and 18, the system allows the filtering of programs through at least one criterion required for funding/advisory providers with regard to equity. A criterion related to general information may comprise the name of the funding/advisory program, the program's sponsor, a brief description of the funding/advisory program and the funding/advisory provider's website. A criterion related to program parameters may comprise selecting all eligible provinces, specification of the industry sector(s) covered by this program and selection of the areas of operation admissible for funding. A criterion related to eligible recipients may comprise the type ob business, the specificity of group targeting, the type of company ownership targeted and specification of the eligibility criteria for the beneficiary company such as the total number of full-time employees, total revenues in the last fiscal year, years in business. A criterion related to funding limits may comprise the funding limits of the program and the type of investment situation sought. A criterion related to additional information may comprise any additional comments on the funding/advisory program, as well as contact information.

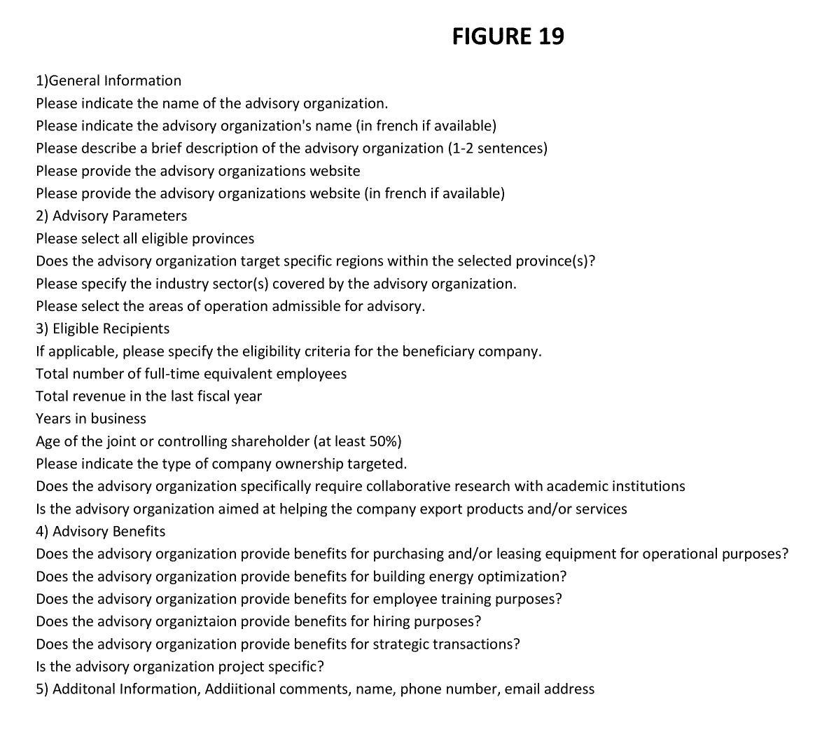

Referring now to FIG. 19, the system allows the filtering of programs through at least one criterion required for funding/advisory providers with regard to advisory services. A criterion related to general information may comprise the name of the funding/advisory organization, a brief description of the funding/advisory program and the funding/advisory organization's website. A criterion related to advisory parameters may comprise selecting all eligible provinces, specification of the industry sector(s) covered by the advisory, and selection of the areas of operation admissible. A criterion related to eligible recipients may comprise the type of business, the type of company ownership started, specification of collaborative research with academic institutions, specification of aim at helping the company export products and/or services and specification of the eligibility criteria for the beneficiary company such as the total number of full-time employees, total revenues in the last fiscal year, years in business, age of the joint or controlling shareholder. A criterion related to advisory benefits criteria may comprise the following criteria: does the advisory organization provide benefits for purchasing and/or leasing equipment for operational purposes, does the advisory organization provide benefits for building energy optimization, does the advisory organization provide benefits for employee training purposes and does the advisory organization provide benefits for hiring purposes. As well, provision of benefits for strategic transactions and provision of program specificity are considered. A criterion related to additional information may comprise any additional comments on the funding/advisory program, as well as contact information.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

What is claimed is:

1. A system for interactive identification and matching of funding or advisory seekers and funding or advisory providers or their programs, the system comprising:
a. at least one server;
i. configured to store a first set of identification data and a first set desired criteria data related to each said program;
ii. configured to store a second set of identification data and a second set of selection criteria data related to each said seeker;
iii. configured to fetch program data matching to the said criteria data related to each said seeker;
b. at least one storage service configured to persist said program data and said seeker data;
c. at least one client input/output device connectable to the said server;
wherein the at least one server, the at least one storage service and the at least one client device are connectable through a communication network.

2. The system for interactive identification and matching according to claim 1, wherein the at least one server and the at least one storage service are installed on the same physical machine.

3. The system for interactive identification and matching according to claim 1, wherein the at least one server comprises an application server.

4. The system for interactive identification and matching according to claim 1, wherein the at least one server comprises a web server.

5. The system for interactive identification and matching according to claim 1, wherein the communication network is the Internet.

6. A method for interactive identification and matching of funding or advisory seekers and funding or advisory providers or their programs, the method comprising:
a. inputting into an input/output device a first set of identification data and a first set desired criteria data related to each said program;
b. validating said program data;
c. classifying the validated program data;
d. storing said program data on a data server.

7. A method for interactive identification and matching according to claim 6, wherein the inputting of the program data is realized by an automatic identification, processing, and/or inputting algorithm.

8. A method for interactive identification and matching according to claim 6, wherein the inputting of the program data is realized by manual inputting by the funding/advisory provider.

9. A method for interactive identification and matching according to claim 6, wherein the inputting of the program data is realized by manual inputting by a third party.

10. A method for interactive identification and matching according to claim 6, wherein the validation of the inputted data may assign the status incomplete or under review to the program.

11. A method for a funding or advisory seeker to identify and select one or more funding or advisory programs offered by providers based on at least one seeker selected criteria, the method comprising:
a. inputting into an input/output device a first set of identification data and a first set provider selected criteria data related to each said program;
b. inputting into an input/output device a second set of seeker identification data and a second set of seeker selected funding or advisory needs data;
c. matching the seeker selected funding/advisory needs data to the provider selected criteria;
d. displaying a list of the programs corresponding to the results of said matching;
e. selecting at least one program from said displayed list.

12. The identification and selection method of claim 11 further comprising the step of rating the selected program.

13. The identification and selection method of claim 11 further comprising the step of filtering by the seeker of the programs displayed in said list.

14. The identification and selection method of claim 11 further comprising the step of allowing said seeker to electronically apply for a selected program.

15. The identification and selection method of claim 11 further comprising the step of allowing said seeker to apply for a selected program using an automated means for completing the application process.

16. The identification and selection method of claim 15 further comprising the step of rating the selected program after applying for said program.

17. The identification and selection method of claim 14, further comprising the step of using the said rating of selected program as a social and feedback oriented parameter when filtering the matching results.

18. A method for funding or advisory seeker to identify and select one or more funding or advisory programs offered by providers as described in claim 1, the method further comprising the steps for:
a. accessing the system through a public central access point;
b. registering said user to the system;
c. authenticating said user to the system;
d. funding/advisory needs;
e. updating program information;
f. creating new program information;
g. validating program related information

19. A method for a user to navigate through the system according to claim 18, wherein the registering of a new user to the system allows a new funding/advisory seeker user to filter, browse and consult aggregate results.

20. A method for a user to navigate through the system according to claim 18, wherein the authenticating of a user to the system requires the sending of an authentication notification and the confirmation of the authentication notification by the user.
